(19) United States
(12) Patent Application Publication
(10) Pub. No.: US 2011/0176750 A1
(43) Pub. Date: Jul. 21, 2011

(54) FOLDABLE BAG

(76) Inventor: Kevin Keller, Austin, TX (US)

(21) Appl. No.: 13/010,349

(22) Filed: Jan. 20, 2011

Related U.S. Application Data
(60) Provisional application No. 61/296,712, filed on Jan. 20, 2010.

(51) Int. Cl. B65D 33/06; B65D 30/10; B31B 1/86; B31B 1/62; B31B 29/26

(52) U.S. Cl. 383/12; 383/105; 493/210; 493/226; 493/264; 493/244

(57) ABSTRACT

A foldable bag includes a thin film sheet and a plurality of spaced panels attached to the thin film sheet. Edges of the thin film sheet are coupled. Interstices between the spaced panels form hinges that permit folding, unfolding and compact refolding of the bag.

### PRIORITY CLAIM

The present application claims priority to U.S. Provisional Application Ser. No. 61/296,712, filed Jan. 20, 2010, which is incorporated herein by reference in its entirety.

### BACKGROUND OF THE INVENTION

1. Technical Field

The present invention relates in general to a foldable bag.

2. Description of the Related Art

Conventionally, retailers have provided complimentary paper and/or disposable plastic shopping bags to customers to facilitate carrying of purchased articles. In general, disposable plastic shopping bags, which are commonly made of polyethylene, have become the most prevalent because of their low cost, relatively high tensile strength, and ease of carrying utilizing the bags' integral handle(s).

Unfortunately, disposable plastic shopping bags are often discarded after a single use, in part because of the lack of cost (and therefore value) to the consumer and in part because disposable plastic shopping bags cannot readily be returned to a compact, organized form following use. The discarding of disposable plastic shopping bags by millions of consumers cumulatively creates significant waste that degrades to its constituent elements very slowly. Further, disposable plastic shopping bags are difficult to recycle and often are not accepted in municipalities' single stream recycling systems. Consequently, many municipalities have drafting ordinances aimed at reducing the volume of disposable shopping bags manufactured and/or entering the waste collection system. These efforts include, for example, voluntary or mandatory disposable plastic bag recycling programs, bans on disposable plastic shopping bags, taxes on disposable plastic bags, mandatory offering of reusable shopping bags, and providing incentives to retailers to charge for disposable plastic bags or credit customers for bringing their own reusable bags.

Consumer use of disposable plastic shopping bags would obviously be significantly reduced if the use of reusable shopping bags were widely adopted by consumers. However, consumers frequently do not have reusable shopping bags with them when they shop, due to inadvertence and/or because reusable shopping bags, which are commonly made of polypropylene, nylon, canvas, or the like, are frequently heavy and bulky and therefore inconvenient for consumers to keep with them.

### SUMMARY OF THE INVENTION

In some embodiments, a foldable bag includes a thin film sheet and a plurality of spaced panels attached to the thin film sheet. Edges of the thin film sheet are coupled. Interstices between the spaced panels form hinges that permit folding, unfolding and compact refolding of the bag.

### BRIEF DESCRIPTION OF THE DRAWINGS

FIGS. 1A-1B depict exemplary embodiments of a foldable bag;

FIG. 2 is a high level logical flowchart of an exemplary method of producing a foldable bag in accordance with one embodiment;

FIG. 3 illustrates the assembly of panels to the base film in accordance with one embodiment;

FIG. 4 depicts an exemplary panel geometry in accordance with one embodiment;

FIG. 5 illustrates the assembly of bag sides and handle in accordance with one embodiment;

FIG. 6A depicts an assembled bag after a first folding step in accordance with one embodiment;

FIG. 6B illustrates an assembled bag after a second folding step in accordance with one embodiment;

FIG. 6C depicts an assembled bag after a third folding step that yields the folded state of the bag in accordance with one embodiment;

FIGS. 7A-7B illustrate a first alternative embodiment of the base thin film and panel assembly in which the panels are connected;

FIG. 8 depicts a second alternative embodiment of the base film and panel assembly in which the panels have nonlinear edges; and

FIGS. 9A-9B illustrate the attachment of panels formed from stock material to the thin film sheet.

### DETAILED DESCRIPTION OF ILLUSTRATIVE EMBODIMENT

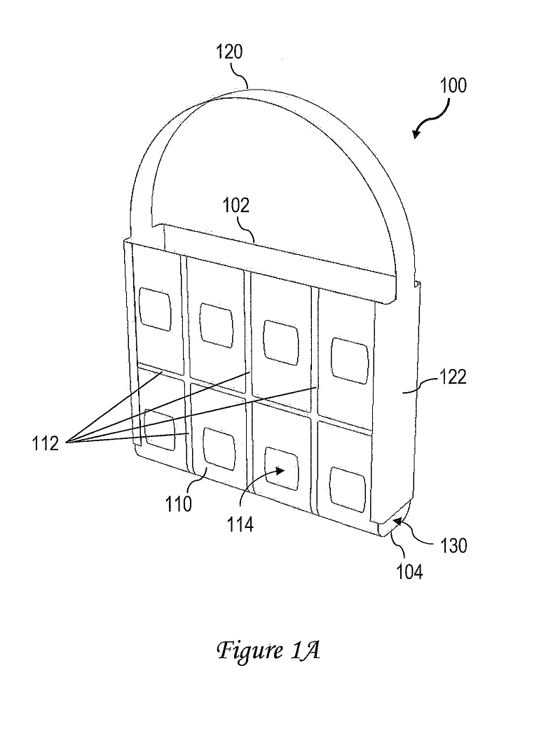

With reference now to the figures and with particular reference to FIGS. 1A-1B, there are illustrated exemplary embodiments of a foldable bag 100. In the various figures, like reference numerals are utilized to identify like or corresponding features.

As described further below, foldable bag 100 can be folded for convenient transport, unfolded for use in carrying one or more articles, and then restored to a compact folded form. To achieve a compact folded form, it is preferred if the base material from which foldable bag 100 is made is thin. Conventional thin materials do not have a predefined structure and are therefore difficult to manipulate and do not retain their shape very well. Accordingly, foldable bag 100 preferably includes seams or hinges defined by the construction of the bag along which foldable bag 100 can be repeatedly folded, unfolded and refolded. In a preferred embodiment, the seams or hinges are formed by the interstices between panels attached to a base thin film. Thus, the embodiments of foldable bag 100 depicted in FIGS. 1A-1B can be described as including a preferably (but not necessarily) unitary thin film sheet 102 to which a plurality of spaced panels 110 are attached, such that interstices 112 between panels 110 form hinges that permit folding, unfolding and compact refolding of the bag.

Edges of thin film sheet 102 are coupled, either by direct attachment or by another member, to define an interior volume of foldable bag 100. In the embodiment illustrated in FIG. 1A, edges of thin film sheet 102 are coupled by side panels 122 formed of a separate member. In the embodiment shown in FIG. 1B, edges of thin film sheet 102 extend to form integral side panels 122 that are directly attached. As shown in both FIGS. 1A-1B, side panels 122 may only extend along only a portion of the opposed edges of thin film sheet 102. In embodiments in which side panels 122 extend along only a portion of the opposed edges of thin film sheet 102, foldable bag 100 may have a relief 130 (best seen in FIG. 1A) in the lower corner of each side, which allows thin film sheet 102 to flatten to form a bottom 104 when foldable bag 100 is loaded with objects. Foldable bag 100 may further include an optional handle assembly 120 coupled to (i.e., integral to, directly attached to, or indirectly attached to) thin film sheet 102 to facilitate carrying of foldable bag 100. In the embodiment depicted in FIG. 1A, handle assembly 120 is integral to side panels 122. In other embodiments, handle assembly 120 may be integral to thin film sheet 102 or may be directly attached to thin film sheet 102, as shown in FIG. 1B.

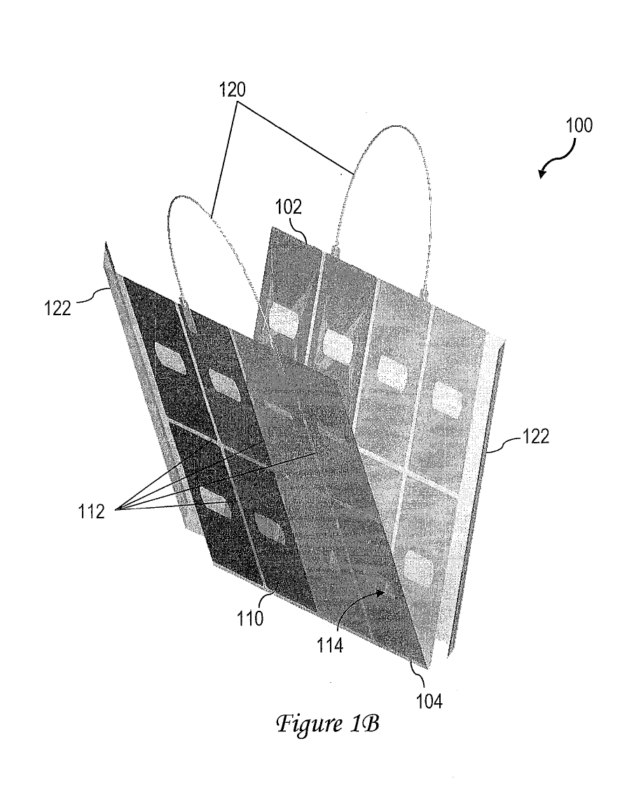

Referring now to FIG. 2, there is depicted a high level logical flowchart of an exemplary method of producing a foldable bag, such as the exemplary embodiments of foldable bag 100 of FIGS. 1A-1B, in accordance with one embodiment. As a logical, rather than strictly chronological flowchart, it should be understood that it is possible to perform at least some of the depicted steps concurrently or in a different order than illustrated.

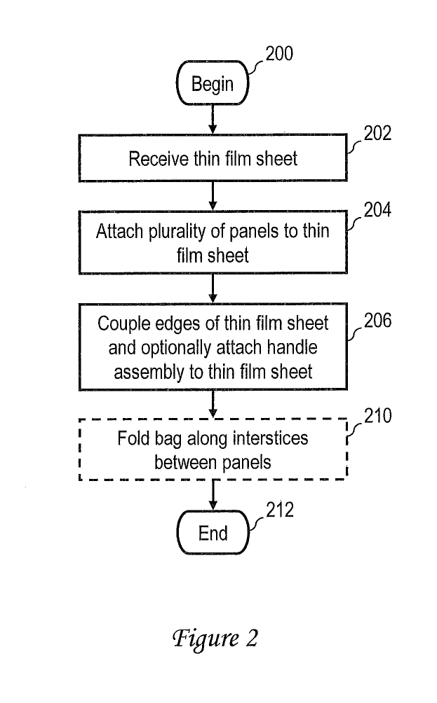

The depicted process begins at block 200 and then proceeds to block 202, which depicts receiving a thin film sheet 102. As noted above and as depicted in FIG. 3, in one embodiment thin film sheet 102 is a unitary piece that forms the principal surfaces of the bag. In alternative embodiments, thin film sheet 102 may be formed of two or more individual sheets joined by adhesive, heat sealing, sonic welding, etc. Thin film sheet 102 is preferably formed of a material (e.g., polyester) that is thin, strong, flexible and resistant to tearing to increase the durability and useful life of foldable bag 100. Thin film sheet 102 may have a thickness, for example, of between 0.5 and 2 mils and, more particularly, of about 1 mil (0.001 inch). Use of a thin material for thin film sheet 102 permits foldable bag 100 to be folded into compact form, while permitting the volume when open to remain large. Thin film sheet 102 may conveniently be cut to desired dimensions from a roll of stock utilizing a rotary die cutting process.

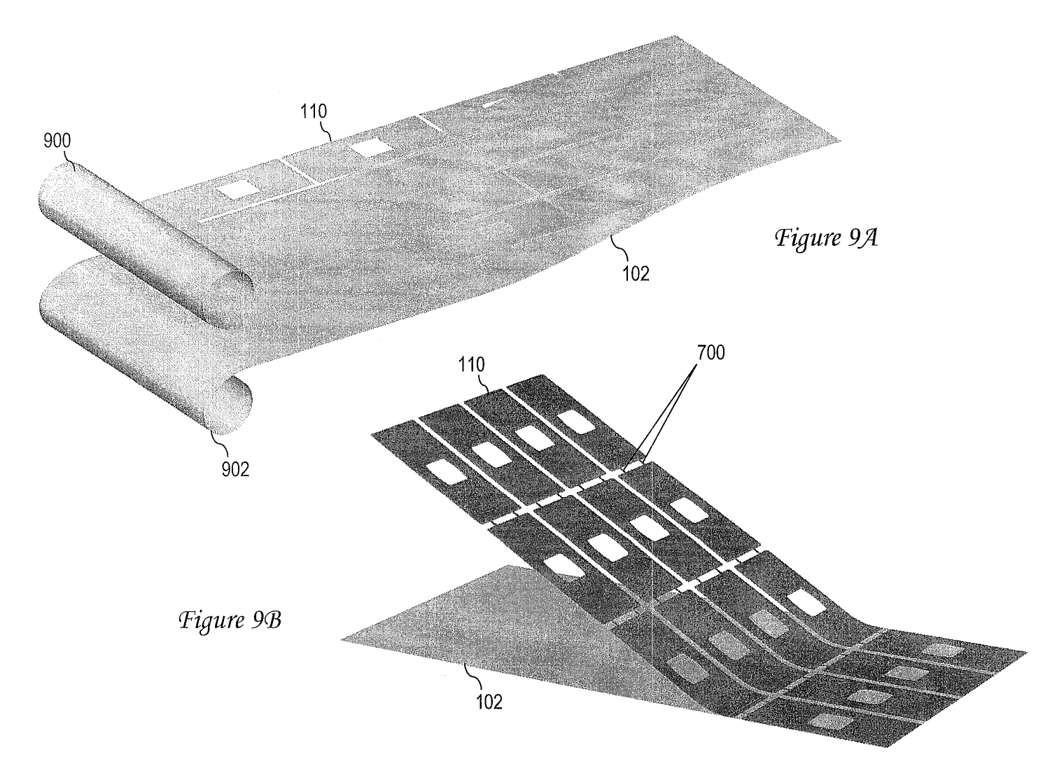

The process of FIG. 2 proceeds from block 202 to block 204, which depicts attaching a plurality of panels 110 to thin film sheet 102 in spaced arrangement. Panels 110, which provide structure and enhanced rigidity to foldable bag 100, can be attached to thin film sheet 102, for example, by adhesive, heat sealing, sonic welding, etc. One preferred method shown in FIG. 9A includes utilizing rotary die cutting to cut panels 110 from a roll 900 of stock material backed with a pressure sensitive adhesive (PSA) or heat sensitive adhesive and to place the panels on thin film sheet 102, which is also fed from a roll 902 of stock. A permanent bond between panels 110 and thin film sheet 102 can then be formed by application of appropriate pressure and/or heat. In one embodiment, panels 110 may be formed of polyester, which is well suited for use in rotary die cutting applications, given the large selection of available stock materials. Panels 110 may have a thickness, for example, of between 1.5 and 10 mils, and more particularly of about 2 mils (0.002″). Panels 110 preferably are stiffer than thin film sheet 102 by virtue of the material or thickness selected for panels 110.

As shown in FIGS. 1A-1B and 3, panels 110 are preferably attached to thin film sheet 102 with spaces or interstices 112 between panels 110 that function as hinges that permit the completed bag assembly to be easily folded in a defined manner. In a preferred embodiment, interstices 112 are preferably relatively small as compared with the size of panels 110 so that when foldable bag 100 is folded, panels 110 readily line up with each other and retain the panel profile. Interstices 112 can be, but are not required to be of equal width. In fact, in one embodiment, panels 110 are arranged on thin film sheet 102 such that an interstice 112a, which bisects the length of thin film sheet 102, has a greater width than the uniform width of the other interstices 112.

To promote easy folding of foldable bag 100, panels 110 preferably all have the same polygonal shape. Although not required, it is also preferable if the common polygonal shape of panels 110 is a convex polygonal shape, such as the rectangular shape depicted in FIGS. 1A-1B and 3. Of course, other polygonal shapes, including concave polygonal shapes, may alternatively be employed. As further depicted in FIGS. 1A-1B and 3, panels 110 may optionally further have an opening 114 formed there through to permit an assembled foldable bag 100 to more easily bend in its folded form, for example, to permit foldable bag 100 to be carried in a conventional bi-fold wallet (i.e., with opening 114 placed at the hinge of the bi-fold wallet).

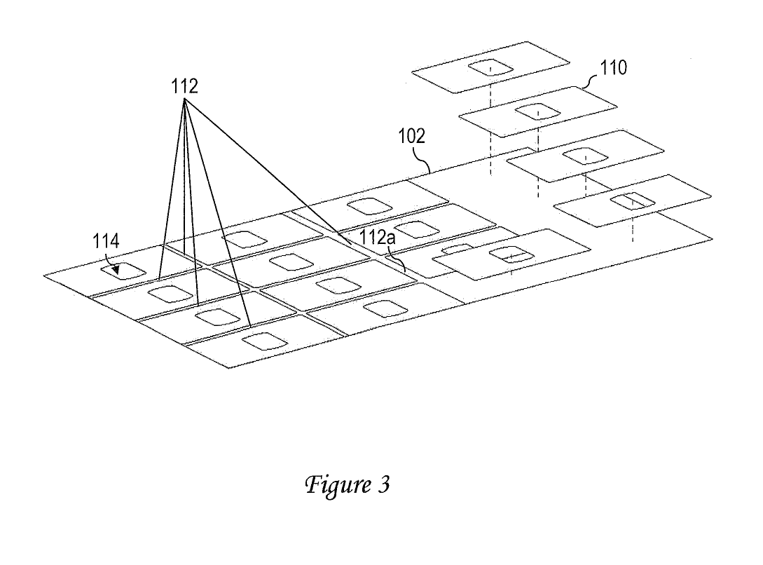

Referring now to FIG. 4, there is depicted one possible arrangement of panels 110 on thin film sheet 102 that can be used for a foldable bag 100 suitable for use as a shopping bag. The depicted arrangement should not be construed in a limiting sense, as other arrangements are possible and may be desirable for shopping bags or other applications.

In the exemplary arrangement, thin film sheet 102 has an overall length of between 20 and 35 inches and an overall width of between 8 and 18 inches. Thin film sheet 102 carries 16 panels 110 having a length of between about 4 and 8 inches and a width of between about 2 and 4 inches. If it desired for the resulting foldable bag 100 to fit in a standard wallet, panels 110 may be further constrained to have a length of between about 5.5 and 7 inches and a width of between about 2.5 and 3.5 inches.

In the exemplary arrangement, interstices 112 generally have a width of about 0.25 inch. As noted above, interstice 112a, which will be disposed at the bottom of the assembled foldable bag 100, may be wider in some embodiments, and in such embodiments may have a width of about 0.50 inch.

Referring again to FIG. 2, the process passes from block 204 to block 206, which illustrates completing the assembly of foldable bag 100 by coupling the edges thin film sheet 102 and attaching an optional handle assembly. In some embodiments, such as the embodiment of FIG. 1B, edges of thin film sheet 102 may be directly attached, for example, by adhesive, heat sealing, or sonic welding. In an alternative embodiment, edges of thin film sheet 102 may be indirectly attached via a separate member, such as side panels 122 of FIG. 1A, which may be formed of the same material as thin film sheet 102 or a different material and may attached to thin film sheet 102 by adhesive, heat sealing or sonic welding. For example, in one embodiment, side panels 122 may be formed of rip stop nylon or a similar lightweight material. In both embodiments in which edges of thin film sheet 102 are directly attached and embodiments in which edges of thin film sheet 102 are coupled by separate side panels 122, a relief 130 can be formed at the lower corner of each side in order to allow thin film sheet 102 to flatten to form a bottom 104 when foldable bag 100 is loaded with objects.

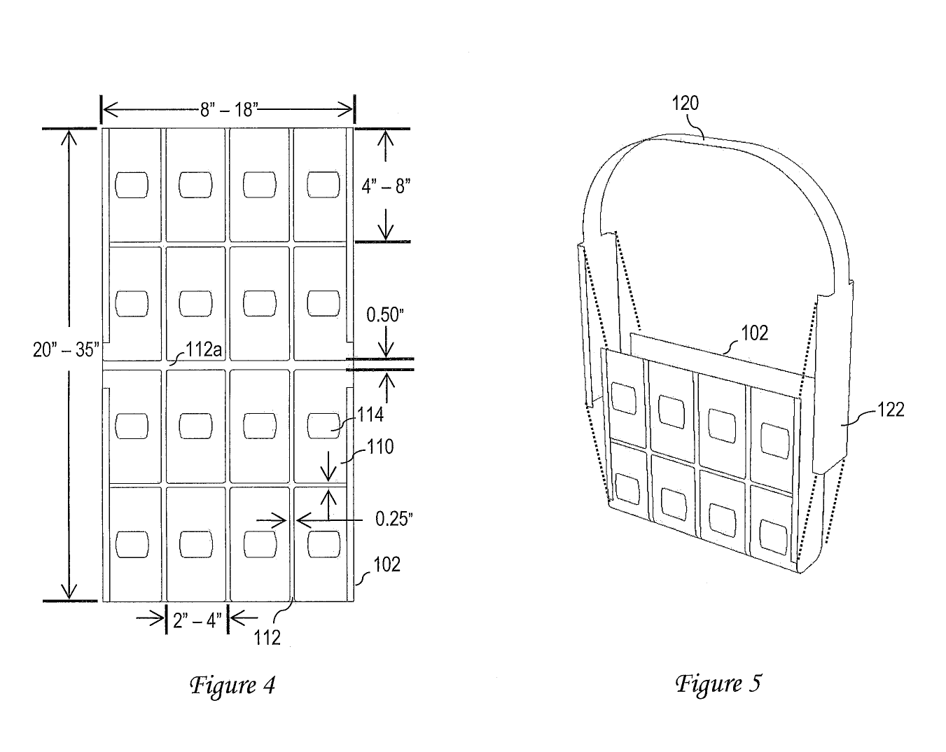

An optional handle assembly 120 may further be coupled to (e.g., integrally formed with, directly attached to, or indirectly attached to) thin film sheet 102 to facilitate carrying foldable bag 100. In one embodiment, handle assembly 120 may be integral with side panels 122 and shown in FIGS. 1A and 5.

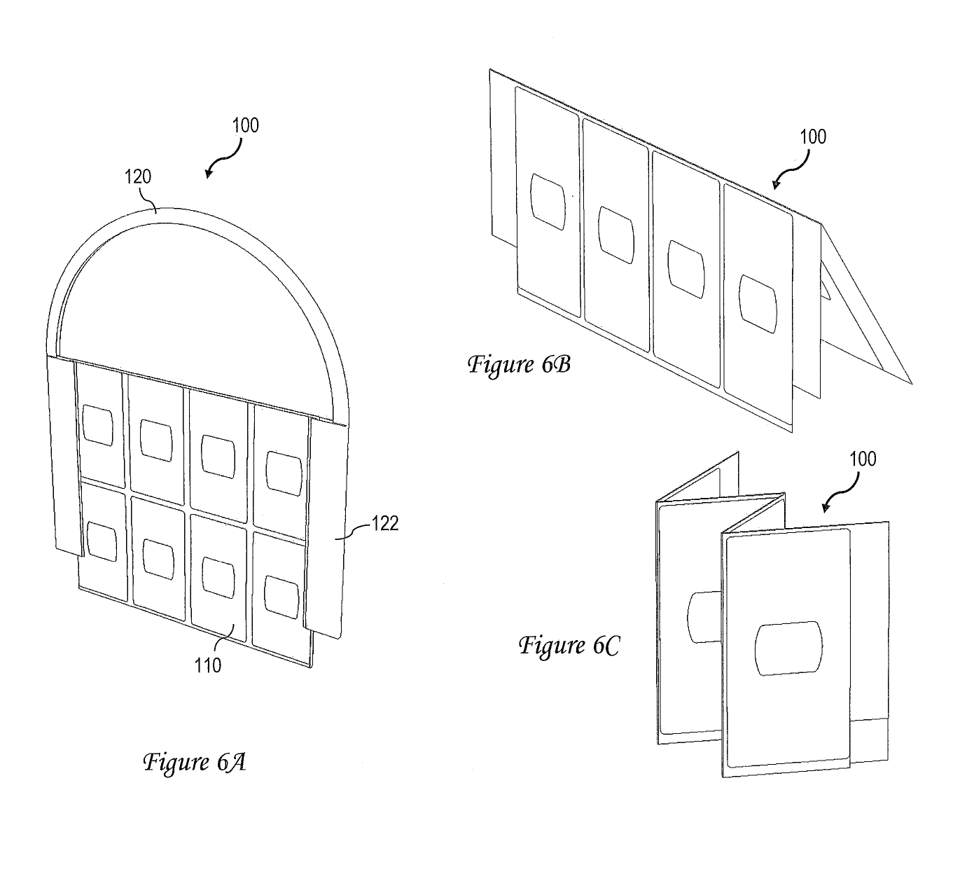

Following block 206, the process passes to optional block 210, which depicts optionally folding the assembled foldable bag 100 into a compact folded form. One exemplary technique for compactly folding a foldable bag 100 having 16 panels 110 is illustrated in FIGS. 6A-6C to which additional reference is now made. As shown in FIG. 6A, foldable bag 102 is first flattened, aligning panels 110 on opposing sides of foldable bag 100. Next, as depicted in FIG. 6B, foldable bag 100 can be folded in half along an interstice 112. Finally, as shown in FIG. 6C, foldable bag 100 can be fan folded to further reduce the profile of foldable bag 100 to approximately the size of a single panel 110. The depicted 16-panel embodiment of foldable bag 100 permits foldable bag 100 to be placed in its compact folded form with a single fold along a horizontal interstice 112 and three folds along vertical interstices 112, achieving a folded form that is relatively thin due to the small number of stacked panels 110. Following block 206, the process depicted in FIG. 2 ends at block 212.

As should be clear from the foregoing description, several parameters of foldable bag 100 can vary between embodiments. These parameters include, without limitation, the method for attaching panels 110 to thin film sheet 102, the size and shape of panels 110, the thicknesses of thin film sheet 102 and panels 110, the number of panels 110, and the materials(s) from which the foldable bag 100 is made.

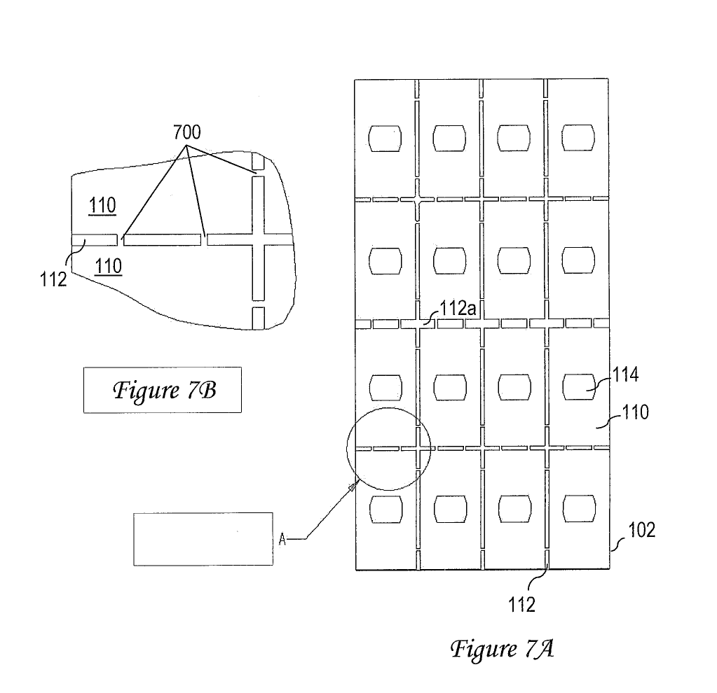

FIGS. 7A-7B illustrate a further variation from previously described embodiments in which panels 110 are not entirely isolated by interstices 112. Instead, as best seen in FIGS. 7B, which depicts a detail of area A of FIG. 7A, at least some of panels 110 are connected with a web of lands 700. In such embodiments, lands 700 are preferably small in size as compared to the width of interstices 112 to permit easy folding of foldable bag 100 along interstices 112. As shown in FIG. 9B, in embodiments in which panels 110 are connected by lands 700, rotary die cutting may also be utilized to cut panels 110 from a roll of stock material, for example, backed with a pressure sensitive adhesive (PSA) or heat sensitive adhesive, and to place the panels on thin film sheet 102, which may also be fed from a roll of stock.

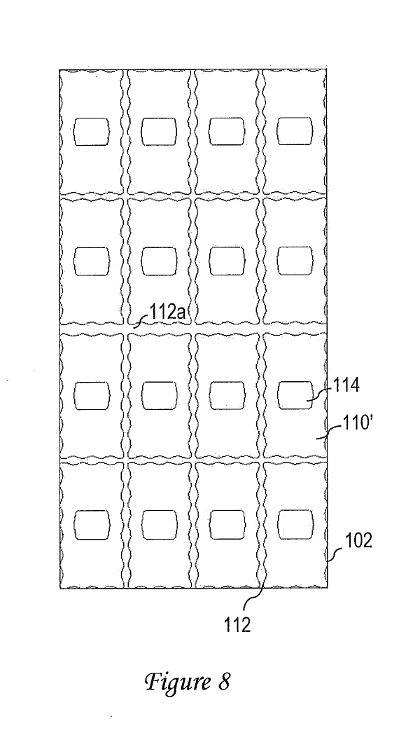

In other variations, panels 110 can be non-rectangular or have non-linear edges (or both). Employing a non-rectangular panel shape enables the foldable bag to be folded in a different base shapes (such as square, triangular, etc.). FIG. 8 depicts a particular embodiment in which panels 110′, while generally rectangular, have non-linear edges.

The foregoing description discloses embodiments in which the material utilized for thin film sheet 102 and panels 110 is polyester. In alternative embodiments, thin film sheet 102 and/or panels 110 may be formed from differing or alternative material(s), such as ABS, cellulose, polycarbonate, polyethylene, polypropylene, PEEK, or flouropolymers (PTFE, PVDF, PFA).

As has been described, in some embodiments a foldable bag includes a thin film sheet and a plurality of spaced panels attached to the thin film sheet, such that interstices between the spaced panels form hinges that permit folding, unfolding and compact refolding of the bag. Edges of the thin film sheet are further coupled to define a bag interior. The foldable bag can be utilized for a number of applications including a shopping bag, product packaging, and general utility use. The panels and thin film sheet may also bear printing for advertising, instructions, warnings, or labeling.

While the invention is susceptible to various modifications and alternative forms, specific embodiments are shown by way of the drawings and will be described in detail. It should be understood that the drawings and detailed description are not intended to limit the invention to the particular form disclosed, but to the contrary, the intention is to cover all modifications, equivalents and alternatives falling within the spirit and scope of the appended claims.

What is claimed is:

1. A foldable bag, comprising:
a thin film sheet; and
a plurality of spaced panels attached to the thin film sheet, such that interstices between the spaced panels form hinges that permit folding, unfolding and compact refolding of the bag;
wherein edges of the thin film sheet are coupled.

2. The foldable bag of claim 1, and further comprising a handle assembly coupled to the thin film sheet.

3. The foldable bag of claim 2, wherein the handle assembly includes side panels coupling edges of the thin film sheet.

4. The foldable bag of claim 3, wherein the handle assembly is formed of a different material than the thin film sheet.

5. The foldable bag of claim 4, wherein the thin film sheet is formed of polyester and the handle assembly is formed of nylon.

6. The foldable bag of claim 1, wherein the thin film sheet is polyester.

7. The foldable bag of claim 1, wherein the plurality of panels have common dimensions.

8. The foldable bag of claim 1, wherein the plurality of panels are convex polygons.

9. The foldable bag of claim 1, wherein the plurality of panels are generally rectangular.

10. The foldable bag of claim 1, wherein the length of the rectangles is in the range of about 4 to 8 inches and the width of the rectangles is in the range of about 2 to 4 inches.

11. The foldable bag of claim 1, wherein at least some of the plurality of panels include an opening there through.

12. The foldable bag of claim 1, wherein the thin film sheet has a thickness of about 0.001 inch.

13. The foldable bag of claim 12, wherein the plurality of panels have a thickness of about 0.002 inch.

14. The foldable bag of claim 1, wherein the interstices isolate the panels.

15. The foldable bag of claim 1, wherein the plurality of panels are interconnected.

16. A foldable bag, comprising:
a thin film sheet;
a plurality of spaced panels attached to the thin film sheet, such that interstices between the spaced panels form hinges that permit folding, unfolding and compact refolding of the bag; and
a handle assembly coupled to the thin film sheet, wherein the handle assembly includes side panels coupling edges of the thin film sheet.

17. A method of producing a foldable bag, comprising:
attaching a plurality of spaced panels to a thin film sheet, such that interstices between the spaced panels form hinges that permit folding, unfolding and compact refolding of the bag; and
coupling edges of the thin film sheet.

18. The method of claim 17, wherein the attaching includes attaching the plurality of spaced panels utilizing adhesive.

19. The method of claim 17, wherein the attaching includes applying heat to the plurality of panels.

20. The method of claim 17, wherein the coupling includes directly attaching the edges of the thin film sheet.

21. The method of claim 17, wherein the coupling includes coupling the edges of the thin film sheet with side panels.

22. The method of claim 17, and further comprising:
coupling a handle assembly to the thin film sheet.

23. The method of claim 22, wherein:
the handle assembly includes side panels; and
coupling the handle assembly includes coupling the side panels to the edges of the thin film assembly.

24. The method of claim 17, and further comprising folding the foldable bag at least once along a vertical interstice and at least once along a horizontal interstice.

25. The method of claim 17, wherein the folding comprises folding the foldable bag into a folded state approximately a size of one of the plurality of panels.
